(19) United States
(12) Patent Application Publication
(10) Pub. No.: US 2025/0296714 A1
(43) Pub. Date: Sep. 25, 2025

(54) VERTICAL TAKEOFF AND LANDING UNMANNED AERIAL VEHICLES SECURED AND UNSUPERVISED CHARGING SYSTEM

(71) Applicant: ALTINBAS ÜNIVERSITESI, Istanbul (TR)

(72) Inventors: Dogu Çagdas ATILLA, Istanbul (TR); Maigalisa YOHANNA, Istanbul (TR)

(73) Assignee: ALTINBAS ÜNIVERSITESI, Istanbul (TR)

(21) Appl. No.: 18/839,745

(22) PCT Filed: Dec. 14, 2022
(86) PCT No.: PCT/TR2022/051497

§ 371 Date: Aug. 20, 2024

(51) Int. Cl. B64U 50/37; B64U 70/80

(52) U.S. Cl. CPC B64U 50/37; B64U 70/80

(57) ABSTRACT

charging dock system in this invention will provide an unsupervised contact-charging platform for Vertical Take-Off and Landing (VTOL) drones where they can connect to a charger using physical connection terminals, and lock almost immediately as they touch the platform using electromagnetic means. Then upon full charging (or interrupts), they can disengage and deploy to carry out their various tasks.

### TECHNICAL FIELD

This invention is of a Vertical Takeoff and Landing (VTOL) Unmanned Aerial Vehicles (or drones) Secured and Unsupervised Charging (MagSecure Charger) system.

### PRIOR ART

The use of drones has become ingrained in every part of our society today, from different fields of use like surveillance, agriculture, entertainment, and most importantly transport/logistics. Therefore, with such an increase in work demands, there is a need for charging these drones in a more effective fashion, especially unsupervised or autonomously.

There are many existing designs for charging drones (unsupervised) using docks and charging pads or stations. However, most of the technologies used in this process employ wireless coupling means & sources. Proximity is key with wireless charging, not just proximity, in some cases, proper alignment must be attained to have optimized charging. Furthermore, even during an optimized charging instance, wireless charging is never as fast and effective as wired or physical contact charging methods. Considering that these drones are required to charge fast enough to enable quick deployment, fast charging will serve a very important role in such a process.

For other similar inventions that make use of contact charging, there is the challenge of securing the drones to the charging bed, platform, or docks during charging. This is challenging, and many inventions used mechanical clamps, dome covers, retractable platforms, etc. to overcome the challenge, at the expense of charging-transition-time (time between drone shutdown and securing mechanism to lock-during which the drone can be blown away by the elements), the risk of broken propellers (for generic drones using the platform), restriction of charging station to just particular models and makes that can fit entrapment, etc.

The abstract of the prior art patent application US20210053677A1 is as follows; “A charging and recharging drone assembly system and apparatus are provided. The system has a unique charging pad having a plurality of cones which direct the legs of a charging drone into a specific location on the charging pad for charging/re-charging. A QR code may be located in the middle of a cover of a charging pad so that the charging drone may detect the charging pad from the air and may direct the charging drone to land on a specific spot on the landing pad for charging. The movable cover may cover the charging pad when the charging pad is not in use to protect the charging pad.” As can be seen, there is no locking system and solenoid/magnet system for drone charging in this application.

As a result, due to the above-mentioned disadvantages and the inadequacy of the existing solutions, an improvement in the relevant technical field was required.

### PURPOSE OF THE INVENTION

The invention aims to provide a method with different technical characteristics which brings a new perspective in this field, unlike the embodiments used in the present art.

The proposed charging dock in this invention will provide an unsupervised contact-charging platform for Vertical Take-Off and Landing (VTOL) drones where they can connect to a charger using physical connection terminals, and lock almost immediately as they touch the platform using electromagnetic means. Then upon full charging (or interrupts), they can disengage and deploy to carry out their various tasks.

The features in this invention will be very beneficial to drones that are normally deployed for inspections, surveillance, and agricultural purposes, which normally work unsupervised. Here, these docking stations can be placed close to their areas of operations. This provides a big impact and will allow for ease in remote coordination, reduce physical human intervention, increase the speed of charging, and reduce the required manpower and time required for setting up the drone for charging.

Additionally, this will provide a charging system that can support different brands and makes of VTOL drones' charging. All that is required is attaching the device kit and the drone can locate and identify any charging station close to it, and if it is available, provide a charge to the drone.

In order to fulfill the above-described purposes, the invention is a vertical takeoff and landing unmanned aerial vehicles/drones secured and unsupervised charging system characterized by comprising;
Curved dock edges to help guide the drone into position while landing,
Charging conductors to guide the landing supports of the drone without tipping it and ensuring that, at least, two of the four contacts on the drone are engaged,.
A power and data cable, to transfer the power for charging and controlling the electrical locking mechanism as well as taking data back and from the dock to the control unit,
A charging dock base is a mechanical support to hold the charging apparatus in place and housing that protects the electromechanics lock switch,
Ferromagnetic material to interlock with the charging conductors and incorporating to lock the base of the drones in place after landing,.
A charging cable runs from the drone's battery contacts, through the landing supports, to the charging leads that connect with the dock contacts/charging conductors,
A power connector is a connector for charging cables to the charging conductors,
Magnets which attached to a non-conducting spring-loaded shaft (505) magnetize protrusion of ferromagnetic component on contact and demagnetize it while it is pulled away,
A spring-loaded shaft to help push the shaft and magnet back into place after solenoid coil is deenergized,
A solenoid is an electromagnetic solenoid for retracting the lock magnets to allow drones takeoff,
A solenoid assemble housing is a unit block for the solenoid, spring-loaded shaft and magnet,
Connecting cables that send power that energizes the electromagnetic solenoid coil.

The structural and characteristic features and all advantages of the invention will become more apparent from the following figures and the detailed description made with reference to these figures, and therefore the evaluation should be made with reference to these figures and detailed description.

### BRIEF DESCRIPTION OF THE FIGURES

FIG. 1, is a schematic view of the working principle of the invention.

FIG. 2, is a schematic view of the alternative working principle of the invention.

FIG. 3, is a perspective view of the Dock.

FIG. 4, is a perspective view of a kit that is designed to be fitted to any VTOL drones.

FIG. 5, is a cross-section view of the Dock and a mechanism for engaging the lock system.

The drawings do not necessarily have to be scaled and details which are not necessary to understand the present invention may be omitted. Furthermore, elements which are at least substantially identical or at least substantially identical functions are designated by the same number.

### REFERENCE LIST

300. Curved Dock Edges
301. Charging Conductors
302. Power and Data Cable
303. Charging Dock Base
304. Ferromagnetic Material
400. Charging Cable
401. Landing Support
402. Charging Leads
500. Cross-section of Charging Conductors
501. Protrusion of Ferromagnetic Component
502. Power Connector
503. Charging Cable
504. Magnets
505. Spring-Loaded Shaft
506. Solenoid
507. Solenoid Assemble Housing
508. Connecting Cables

### DETAILED DESCRIPTION OF THE INVENTION

In this detailed description, preferred embodiments of the invention are explained for better understanding of the subject matter and with no limiting effect.

This invention is of a Vertical Takeoff and Landing (VTOL) Unmanned Aerial Vehicles (or drones) Secured and Unsupervised Charging (MagSecure Charger).

The functions of the parts in the device subject to the invention are as follows.

Calculated design of slanting curved dock edges (300) to help guide the drone into position while landing.

Gold coated copper charging conductors (301) are carefully engineered to guide the landing supports of the drone without tipping it and ensuring that, at least, two of the four contacts on the drone are engaged.

Power and data cable (302), transferring the power for charging and controlling the electrical locking mechanism as well as taking data back and from the dock to the control unit.

Charging dock base (303) is a mechanical support to hold the charging apparatus in place and housing that protects the electromechanics lock switch.

Ferromagnetic material (304) is designed to interlock with the charging conductors (301), these metals are incorporated to lock the base of the drones in place after landing.

Charging cable (400) runs from the drone's battery contacts, through the landing supports (401), to the charging leads (402) that connect with the dock contacts/charging conductors (301).

Most VTOL drones have landing support (401), they can easily be modified to adapt the charging leads (402).

Charging leads (402) are ferromagnetic conducting materials that have insulations between the charging leads (402) and the landing support: their primary function is to make the electrical contact to provide the charging. They are chamfered at the edges to prevent tilt and also ensure a good base for landing the drones.

Protrusion of ferromagnetic component (501), cross-section to show how the ferromagnetic material (304) is linked with the lock switch.

Power connector (502) is a connector for charging cables (503) to the charging conductors (301).

Permanent Neodymium Magnets (504) attached to a non-conducting spring-loaded shaft (505). It magnetizes protrusion of ferromagnetic component (501) on contact and demagnetizes it while it is pulled away.

Spring-loaded shaft (505) to help push the shaft (and magnet (504)) back into place after solenoid (506) coil is deenergized.

Solenoid (506) is an electromagnetic solenoid for retracting the lock magnets (504) to allow drones takeoff.

Solenoid assemble housing (507) is a unit block for the solenoid (506), spring-loaded shaft (505) and magnet (504) which can easily be serviced or replaced as a unit without changing or affecting the operations of other components.

Connecting cables (508) that send power that energizes the electromagnetic solenoid (506) coil.

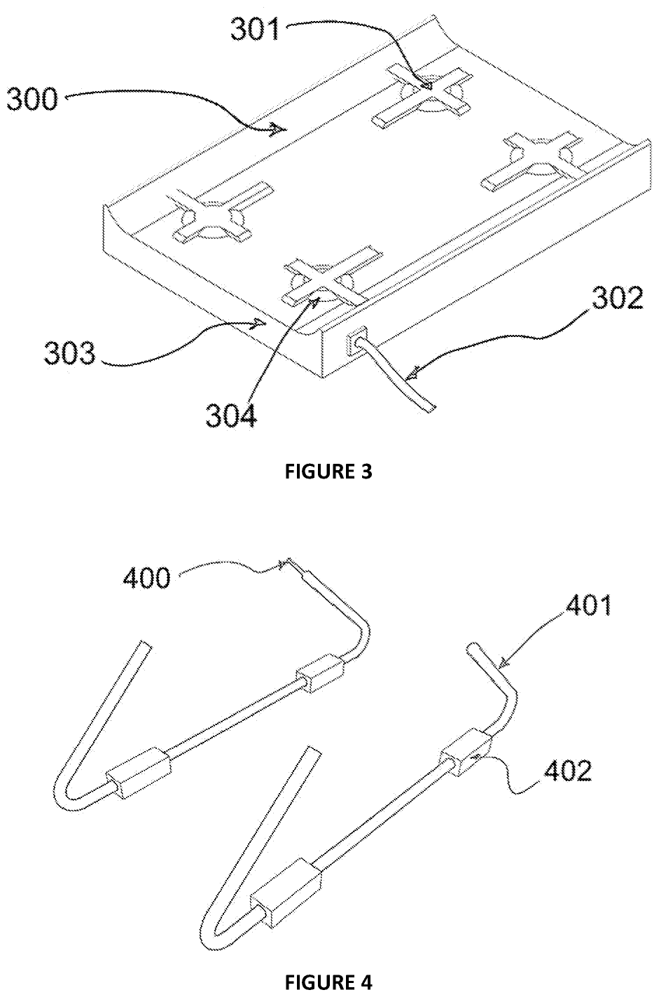

FIG. 3 is the charging dock invention. Here it is presented just as the charging block without its charging and control unit. Just the main block where the crucial part of this invention lies. From the illustration, curved dock edge (300), purposefully engineered to act as a guide to help glide and keep the landing stands of the drones on the platform and to keep it from falling off during landing. Then the cross-shaped charging conductors (301) are designed such that they taper at the curved edges to provide a good glide seating for the landing parts. There are four of these with each one having the ability to switch between polarities (electronically) to match the right drone conductor polarity, which contacts them after landing. The polarity switching is done on the smart charging control unit, which is connected to the changing dock via power and data cable (302). The charging dock base (303) is the base and housing frame for the dock's solenoid mechanism that performs the electro-magnetic operations on the dock.

Furthermore, FIG. 4 is the kit that is designed to be fitted to any VTOL drone which will enable the effective connection of this system. From here, four conductive magnetic elements/charging leads (402). are fitted on the landing supports 401 of the drones (this can be adapted to fit on the various existing landing frames of drones). However, if the drones don't come with landing frames, they can be fabricated to accommodate the kit attachment. The charging contact can be cylindrical, cuboid, conical, or trapezoidal—depending on the environment, size, use, and/or design of the adapting drone. The charging and signal cable (400) will be harnessed and passed through the landing frame. However, if the drone comes with adaptable frames, well-insulated cables can be run on the frame and tightly secured with adhesive resins, tapes, or clips (depending on drone size and design). There are many variations to this design, and cannot all be presented in this document, because they will be unique to the hundreds of brands of drones available in production. But such can easily be designed for prototyping, based on the fitting demands.

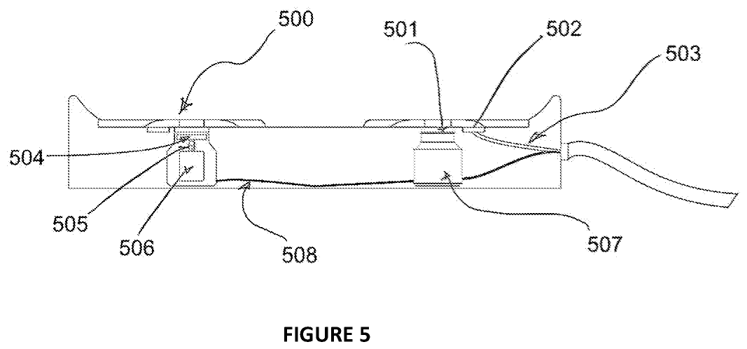

The mechanism for engaging the lock system is illustrated in FIG. 5. From the charging dock's base (303), the lock mechanism is exposed to explain its components and integration. Reference number 500 is a cross-section view of the charging conductors (301), while protrusion of ferromagnetic component (501) is the circular protrusion of the surface ferromagnetic material (304) down through the surface of the dock, to expose the magnetic iron conductor at the base surface of the other side. Power connector (502) is the connection terminal (pad) of the charging cable (503) (coming from the smart charger). Within the solenoid assemble housing (507) is the permanent magnet (504) at the top connected and held in place by a non-magnetic spring-loaded shaft (505). At the OFF state, the solenoid spring keeps the magnet in contact with the base of charging conductors (301) making it ready to lock any approaching magnetic drone connector. After charging (or when a charge interruption command is sent) the solenoid (506) is energized, which in turn pulls magnets (504) away from contacting charging conductors (301) thereby allowing the drone to be able to lift—whenever it is ready. And as soon as the charging leads (402) disconnects from the charging conductors (301), the solenoid (506) is de-energized and the magnets (504) returns to its position with the help of spring-loaded shaft (505). This mechanism provides the perfect lock for charging a drone unsupervised.

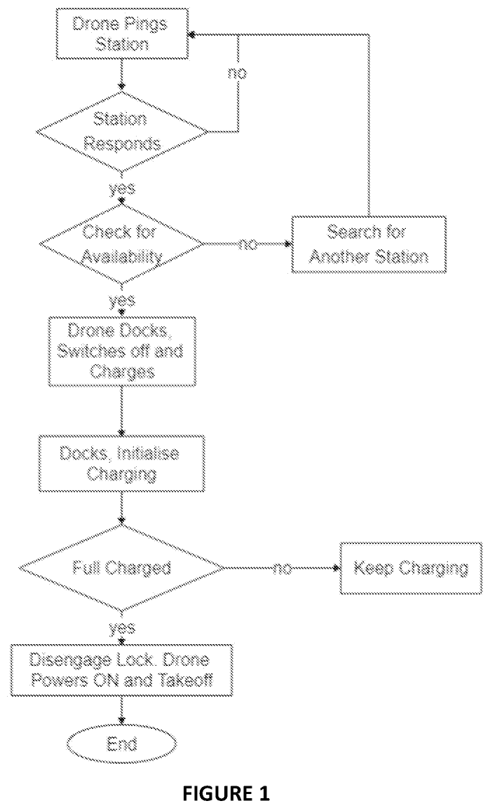

FIG. 1 shows the process steps of the invention.
Drone pings station,
Station responds,
Check for availability, (if not available; search for another station)
Drone docks switches off and charges,
Docks initialize charging
Full charged? (if not fully charged; keep charging),
Disengage lock, Drone powers ON and takeoff,
End.

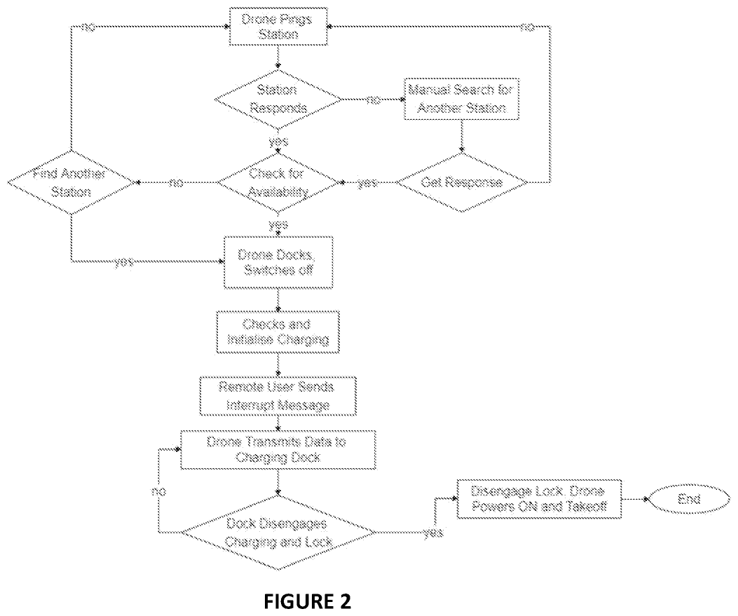

FIG. 2 shows the alternative process steps of the invention.
Drone pings station,
Station responds, (if there is no respond; manuel search for another station)
Check for availability, (if not available; find another station)
Drone docks switches off,
Checks and initialize charging,
Remote user sends interrupt message,
Drone transmits data to charging dock,
Dock disengages charging and lock,
Disengage lock, Drone powers ON and takeoff,
End.

1. A vertical takeoff and landing unmanned aerial vehicles/drones secured and unsupervised charging system characterized by comprising;
Curved dock edges (300) to help guide the drone into position while landing,
Charging conductors (301) to guide the landing supports of the drone without tipping it and ensuring that, at least, two of the four contacts on the drone are engaged,
A power and data cable (302), to transfer the power for charging and controlling the electrical locking mechanism as well as taking data back and from the dock to the control unit,
A charging dock base (303) is a mechanical support to hold the charging apparatus in place and housing that protects the electromechanics lock switch,
Ferromagnetic material (304) to interlock with the charging conductors (301) and incorporating to lock the base of the drones in place after landing,
A charging cable (400) runs from the drone's battery contacts, through the landing supports (401), to the charging leads (402) that connect with the dock contacts/charging conductors (301),
A power connector (502) is a connector for charging cables (503) to the charging conductors (301),
Magnets (504) which attached to a non-conducting spring-loaded shaft (505) magnetize protrusion of ferromagnetic component (501) on contact and demagnetize it while it is pulled away,
A spring-loaded shaft (505) to help push the shaft and magnet (504) back into place after solenoid (506) coil is deenergized,
A solenoid (506) is an electromagnetic solenoid for retracting the lock magnets (504) to allow drones takeoff,
A solenoid assemble housing (507) is a unit block for the solenoid (506), spring-loaded shaft (505) and magnet (504),
Connecting cables (508) that send power that energizes the electromagnetic solenoid (506) coil.

2. The system according to claim 1, characterized by comprising; gold coated copper charging conductors (301).

3. The system according to claim 1, characterized by comprising; permanent neodymium magnets (504).
